(19) United States
(12) Patent Application Publication
(10) Pub. No.: US 2026/0322745 A1
(43) Pub. Date: Oct. 15, 2026

(54) METHODS AND SYSTEMS FOR CONTROLLING PACKET DELIVERY

(71) Applicant: Y.E. Hub Armenia LLC, Yerevan (AM)

(72) Inventor: Sergey KACHEEV, Moscow (RU)

(21) Appl. No.: 19/444,132

(22) Filed: Jan. 8, 2026

(30) Foreign Application Priority Data
Mar. 21, 2025 (RU) 2025106846

(51) Int. Cl. H04L 47/215

(52) U.S. Cl. CPC H04L 47/215

(57) ABSTRACT

Systems and methods for for controlling packet delivery to a server are disclosed. A method includes retrieving, from a memory, a single current state value indicative of a portion of the capacity currently used, and performing one or more operations, using the single current state value, the capacity, and the packet cost. The one or more operations are performed to either selectively dropping in real-time an incoming packet or selectively forwarding in real-time the incoming packet and atomically updating the single current state value stored in the memory. Another method includes in response to one or more of a limit bucket, burst bucket and a global bucket performing one or more operations, either selectively forwarding in real-time the current incoming packet for processing, and atomically removing the packet cost from budgets of at least some buckets or dropping in real-time the current incoming packet.

### CROSS-REFERENCE

The present application claims priority to Russian Patent Application No. 2025106846, entitled “Methods and Systems for Controlling Packet Delivery”, filed Mar. 21, 2025, the entirety of which is incorporated herein by reference.

### FIELD

The present technology relates to network traffic control in general, and more specifically, to methods and systems for controlling packet delivery.

### BACKGROUND

A “kernel” is a main component of an operating system and acts as a bridge between software and hardware in a computer system. For example, the kernel may be responsible for managing hardware resources (e.g., processing units, memory devices) and providing essential services to applications. Linux™ is a known kernel used in some conventional operating systems. Linux-based operating systems combine the Linux kernel with additional software such as utilities, libraries, and tools, for example.

The Linux™ network stack is a layered architecture that enables communication over networks by handling everything from low-level packet transmission to high-level application protocols. A first (highest level) layer is the application layer configured to handle user-facing protocols such as HyperText Transfer Protocol (HTTP), File Transfer Protocol (FTP), and Domain Name System (DNS), for example. Applications use the sockets Application Programming Interface (API) to interact with the network stack for sending and receiving data. A second layer is the transport layer configured for data delivery using protocols such as Transmission Control Protocol (TCP) and User Datagram Protocol (UDP), for example. The transport layer manages flow control, error correction, and session management. A third layer is the network layer configured to handle routing and addressing using Internet Protocols (IP). The network layer may comprise Netfilter tools for packet filtering, Network Address Translation (NAT), and connection tracking. A fourth layer is the data link layer configured to manage frame-level communication and device-specific operations. For example, Network Interface Controller (NIC) drivers operate at the data link layer for interfacing with the hardware. A fifth (lowest level) layer is the physical layer configured for transmitting raw bits over physical media such as as cables and wireless signals, for example.

It should be noted that eXpress Data Path (XDP) is a technology implemented at the data link layer, at the interface between a NIC driver and the rest of network stack. Broadly, XDP technology is configured to process packets immediately after they are received by the NIC driver, and before they enter upper layers of the network stack. It should be noted that XDP technology can use Extended Berkeley Packet Filter (eBPF) technology to execute customizable programs directly in the Linux™ kernel. XDP technology can be used for packet filtering and redirection, load balancing, and Distributed Denial of Service (DDoS) mitigation.

Domain Name System (DNS) servers are components in modern networking architectures that can provide resolution of domain names into IP addresses and vice versa. DNS servers typically comprise hardware and software configurations, often hosted on dedicated computers running operating systems. The challenge of protecting DNS servers from DDOS attacks can arise from scenarios where one or more clients “flood” the DNS server with a high volume of requests, potentially overwhelming a capacity of the DNS server.

CN113422737 discloses a traffic control method with flow control equipment and a storage medium.

### SUMMARY

It is an object of the present technology to ameliorate at least some of the inconveniences present in the prior art. Embodiments of the present technology may provide and/or broaden the scope of approaches to and/or methods of achieving the aims and objects of the present technology.

### DDoS using XDP

It should be noted that there are several limitations with designing packet delivery control systems using XDP for DDOS mitigation.

Developers have realized that packets are to be handled by the XDP in real-time, which prevents the use queuing mechanisms. In other words, there is no “queue” or buffer to hold packets for later/delayed decisions. One or more packets are handled by XDP in the data link layer as they arrive via the physical layer, in a queue-free environment that requires immediate action based on current state parameters.

It should be noted that in queue-based approaches, packets are stored in a queue and processed by a secondary thread. If a packet doesn't meet given conditions, the packet may be returned to the queue or dropped after a timeout. This results in slower packet processing and increased complexity due to queuing and thread synchronization. In contrast, XDP-based request-limiting system disclosed herein is configured to perform decision-making in real-time, making it suitable for high-throughput environments. To that end, the XDP-based request-limiting system comprises a packet bucket that does not store the packets in queues. As a result, a bucket state can be maintained using a single timestamp parameter (as opposed to at least two parameters in traditional queue-based approaches) that is atomically updated for real-time applications.

Developers have realized that eBPF instructions used for XDP should function independently of a control plane to increase resilience of the packet delivery control system. If the control plane “crashes”, the failure should not disrupt operation of the packet delivery control system using XDP. This means that a packet delivery control system using XDP should operate entirely within the data plane, without reliance on external controllers (e.g., in the control plane).

In at least one aspect of the present technology, developers have devised a packet delivery control system using XDP that is resilient to external control plane failures.

In the context of the present technology, an “atomic operation” is an operation on a data structure that is guaranteed to occur in a single, indivisible unit, ensuring no intermediate state is visible to other threads and/or processes.

Developers have realized that parameter updating is limited in XDP. It should be noted that synchronization primitives such as “bpf_spin lock”, for example, are unavailable in XDP. Parameter updating may be implemented in XDP using atomic operations enabled via eBPF. This limitation of XDP enabled via eBPF prevents the use of traditional locking mechanisms for managing shared state parameters and necessitates designing algorithms with lock-free data structures by employing atomic operations.

In at least one aspect of the present technology, developers have devised a packet delivery control system using XDP configured to update bucket states using atomic operations.

In the context of the present technology, a bucket structure, or simply “bucket”, refers to a data structure used to store or categorize packets based on specific attributes, such as hash values, packet types, or keys. Different bucket architectures can be employed in conjunction with eBPF maps to process, count, or classify incoming packets.

Developers have realized that XDP prevents the use of background processes and/or threads. Operations must occur synchronously during processing of packets in a bucket structure. For example, a given bucket must be updated in real-time as packets are received, rather than relying on a background thread to manage further replenishment of the given bucket. It should be noted that in queue-based approaches, packets are stored in a queue and processed by a secondary thread. If a packet doesn't meet given conditions, the packet may be returned to the queue or dropped after a timeout. This results in slower packet processing and increased complexity due to queuing and thread synchronization.

In at least one aspect of the present technology, developers have devised a packet delivery control system using XDP configured to performs operations in real-time without relying on queuing and/or background threads.

Developers have realized that convectional bucket designs require maintaining a bucket state in a form of at least two parameters comprising a first parameter indicative of a number of packets, and a latest updated timestamp parameter. However, since different bucket architectures including a large number of buckets can be implemented in XDP, it is desired to reduce a memory requirement for storing respective bucket states. Also, to maintain high speed packet handling in XDP, some operations should be avoided (e.g., division operations) as they are computationally expensive.

In at least one aspect of the present technology, developers have devised a packet delivery control system using XDP configured to implement single-parameter bucket states for reducing memory requirements and/or avoiding computationally expensive operations to maintain high-speed processing.

### Multi-Client Bandwidth Optimization

Developers have realized that clients utilize their bandwidth quotas with a given server at varying speeds. Some underutilize their quota (maximum allowable rate), leaving server capacity underused, while others exceed their quota and may experience degraded service or denial of access. Developers have realized that a mechanism is required to identify underutilized quotas and allocate this bandwidth to other client without exceeding the global bandwidth limit. Design of bandwidth sharing mechanisms that operate in real-time without overloading a server is a challenge.

Developers have realized that a global bandwidth limit must not be breached, as exceeding it could lead to an increased vulnerability to DDoS attack on the server. Also, opportunistic sharing of unused bandwidth introduces a risk of abuse by malicious actors that may exploit the bandwidth sharing system to generate DDoS-like traffic.

Developers have realized that a hierarchical token bucket may be used for managing quotas, but the existing solutions do not support real-time sharing of unused bandwidth in a queue-free and a lock-free environment.

In some embodiments of the present technology, there are provided systems and methods utilizing a Hierarchical Token Bucket (HTB) architecture for XDP-based request-limiting system. The HTB architecture comprises a global bucket that encompasses all clients, providing protection against breaches of global bandwidth limits. The global bucket comprises main buckets for handling clients with pre-determined Committed burst size (CBS) and a specialized bucket for handling clients without a CBS. It is contemplated that the specialized bucket implements a limit_any scheme, dynamically allocating sub-buckets for new clients in this category, with each sub-bucket's Information Rate (IR) set as a proportional share of the Overall Information Rate (OIR) of the specialized bucket.

In some aspects, the techniques described herein relate to a system for controlling packet delivery to a server, the system including a bucket structure having a capacity and a packet cost, the capacity being indicative of a pre-determined number of packets that can be forwarded by the bucket structure at a given moment in time, the packet cost being indicative of a pre-determined portion of the capacity that a given packet uses if forwarded by the bucket structure; the system being configured to: retrieve, from a memory, a single current state value indicative of a portion of the capacity currently used; perform one or more operations, using the single current state value, the capacity, and the packet cost, to either: selectively drop in real-time an incoming packet; or selectively forward in real-time the incoming packet and atomically update the single current state value stored in the memory.

In some aspects, the techniques described herein relate to a system, wherein the incoming packet is provided at a current timestamp indicated by a system clock, to perform the one or more operations includes the system configured to: determine a first sum between the single current state value and the packet cost, the first sum being indicative of a projected portion of the capacity used at the given moment in time; determine a second sum between the current timestamp and the capacity, the second sum being indicative of a capacity limit at the given moment in time; if the first sum is above the second sum, and thereby the projected portion is above the capacity limit: selectively drop in real-time the incoming packet; and if the first sum is below the second sum, and thereby the projected portion is below the capacity limit: selectively forward in real-time the incoming packet for processing; and atomically update the single current state value stored in the memory, so that a single updated state value corresponding to the first sum is stored in the memory.

In some aspects, the techniques described herein relate to a system, wherein the system is further configured to: retrieve, from the memory, the single updated state value indicative of an updated portion of the capacity currently used; perform one or more operations, using the single updated state value, the capacity, and the packet cost, to either: selectively drop in real-time a second incoming packet; or selectively forward in real-time the second incoming packet for processing and atomically update the single updated state value stored in the memory.

In some aspects, the techniques described herein relate to a system, wherein the system is a queue-less system.

In some aspects, the techniques described herein relate to a system, wherein the system is a lock-less state system.

In some aspects, the techniques described herein relate to a system, wherein the system is a thread-less system.

In some aspects, the techniques described herein relate to a system, wherein the system is an express Data Path (XDP) configuration using an Extended Berkeley Packet Filter (eBPF).

In some aspects, the techniques described herein relate to a system, wherein the incoming packet is acquired using a Network Interface Controller (NIC) of the server.

In some aspects, the techniques described herein relate to a system, wherein the server is a Domain Name System (DNS) server, and the incoming packet is a DNS incoming packet, and the system is configured to prevent a Distributed Denial of Service (DDoS) attack on the DNS server.

In some aspects, the techniques described herein relate to a system, wherein the single current state value is only one current state value.

In some aspects, the techniques described herein relate to a method of controlling packet delivery to a server, the method executable by a system, the system including a bucket structure having a capacity and a packet cost, the capacity being indicative of a pre-determined number of packets that can be forwarded by the bucket structure at a given moment in time, the packet cost being indicative of a pre-determined portion of the capacity that a given packet uses if forwarded by the bucket structure; the method including: retrieving, from a memory, a single current state value indicative of a portion of the capacity currently used; performing one or more operations, using the single current state value, the capacity, and the packet cost, for either: selectively dropping in real-time an incoming packet; or selectively forwarding in real-time the incoming packet and atomically updating the single current state value stored in the memory.

In some aspects, the techniques described herein relate to a method, wherein the incoming packet is provided at a current timestamp indicated by a system clock, the performing the one or more operations includes: determining a first sum between the single current state value and the packet cost, the first sum being indicative of a projected portion of the capacity used at the given moment in time; determining a second sum between the current timestamp and the capacity, the second sum being indicative of a capacity limit at the given moment in time; if the first sum is above the second sum, and thereby the projected portion is above the capacity limit: selectively dropping in real-time the incoming packet; and if the first sum is below the second sum, and thereby the projected portion is below the capacity limit: selectively forwarding in real-time the incoming packet for processing; and atomically updating the single current state value stored in the memory, so that a single updated state value corresponding to the first sum is stored in the memory.

In some aspects, the techniques described herein relate to a method, wherein the method further includes: retrieving, from the memory, the single updated state value indicative of an updated portion of the capacity currently used; performing one or more operations, using the single updated state value, the capacity, and the packet cost, for either: selectively dropping in real-time a second incoming packet; or selectively forwarding in real-time the second incoming packet for processing and atomically update the single updated state value stored in the memory.

In some aspects, the techniques described herein relate to a method, wherein the system is a queue-less system.

In some aspects, the techniques described herein relate to a method, wherein the system is a lock-less state system.

In some aspects, the techniques described herein relate to a method, wherein the system is a thread-less system.

In some aspects, the techniques described herein relate to a method, wherein the system is an express Data Path (XDP) configuration using an Extended Berkeley Packet Filter (eBPF).

In some aspects, the techniques described herein relate to a method, wherein the method further includes acquiring the incoming packet using a Network Interface Controller (NIC) of the server.

In some aspects, the techniques described herein relate to a method, wherein the server is a Domain Name System (DNS) server, and the incoming packet is a DNS incoming packet, and the method includes preventing a Distributed Denial of Service (DDoS) attack on the DNS server by dropping the incoming packet.

In some aspects, the techniques described herein relate to a method, wherein the single current state value is only one current state value.

In some aspects, the techniques described herein relate to a system for controlling packet delivery to a server, the system including: a hierarchical bucket structure for a plurality of clients, the hierarchical bucket structure including: a global bucket structure for incoming packets from the plurality of clients, and a limit bucket structure and a burst bucket structure for incoming packets from a first client from the plurality of clients, the system being configured to: in response to the limit bucket structure allowing the current income packet: selectively forward in real-time the current incoming packet for processing, and atomically remove the packet cost from a budget of the limit bucket structure, a budget of the burst bucket structure and a budget of the global bucket structure; in response to the limit bucket structure not allowing the current incoming packet: determine if the burst bucket structure allows the current incoming packet; in response to the burst bucket structure allowing the current income packet: determine if the global bucket structure allows the current incoming packet; and in response to the global bucket structure allowing the current income packet: selectively forward in real-time the current incoming packet for processing, and atomically remove the packet cost from the budget of the burst bucket structure and the budget of the global bucket structure, while the budget of the limit bucket remains unchanged.

In some aspects, the techniques described herein relate to a system, wherein the limit bucket structure and the burst bucket structure are client-specific bucket structures pre-configured for the first client.

In some aspects, the techniques described herein relate to a system, wherein the limit bucket structure is a first limit bucket structure, and the burst bucket structure is a first burst bucket structure, the first limit bucket structure and the first burst bucket structure being pre-configured to control packet delivery of first incoming packets associated with a first service operated for the first client, the hierarchical bucket structure further including: a second limit bucket structure and a second burst bucket structure for the first client, the second limit bucket structure and the second burst bucket structure being pre-configured to control packet delivery of second incoming packets associated with a second service operated for the first client.

In some aspects, the techniques described herein relate to a system, wherein the burst bucket structure is configured to allow the current incoming packet by performing one or more operations on a single current state value of the burst bucket structure, the budget of the burst bucket structure, and the packet cost of the burst bucket structure.

In some aspects, the techniques described herein relate to a system, wherein the global bucket structure is configured to allow the current incoming packet by performing one or more operations on a single current state value of the global bucket structure, the budget of the global bucket structure, and the packet cost of the global bucket structure, the packet cost of the global bucket structure being equal to the budget of the global bucket structure.

In some aspects, the techniques described herein relate to a system, wherein the burst bucket structure is configured to selectively drop, in real-time, the current income packet.

In some aspects, the techniques described herein relate to a system, wherein the global bucket structure is configured to selectively drop, in real-time, the current income packet.

In some aspects, the techniques described herein relate to a system, wherein the system is a queue-less system.

In some aspects, the techniques described herein relate to a system, wherein the system is a lock-less state system.

In some aspects, the techniques described herein relate to a system, wherein the system is a thread-less system.

In some aspects, the techniques described herein relate to a method of controlling packet delivery to a server, the method executable by a system, the system including a hierarchical bucket structure for a plurality of clients, the hierarchical bucket structure including a global bucket structure for incoming packets from the plurality of clients, and a limit bucket structure and a burst bucket structure for incoming packets from a first client from the plurality of clients, the method including: in response to the limit bucket structure allowing the current income packet: selectively forwarding in real-time the current incoming packet for processing, and atomically removing the packet cost from a budget of the limit bucket structure, a budget of the burst bucket structure and a budget of the global bucket structure; in response to the limit bucket structure not allowing the current incoming packet: determining if the burst bucket structure allows the current incoming packet; in response to the burst bucket structure allowing the current income packet: determining if the global bucket structure allows the current incoming packet; and in response to the global bucket structure allowing the current income packet: selectively forwarding in real-time the current incoming packet for processing, and atomically removing the packet cost from the budget of the burst bucket structure and the budget of the global bucket structure, while the budget of the limit bucket remains unchanged.

In some aspects, the techniques described herein relate to a method, wherein the limit bucket structure and the burst bucket structure are client-specific bucket structures pre-configured for the first client.

In some aspects, the techniques described herein relate to a method, wherein the limit bucket structure is a first limit bucket structure, and the burst bucket structure is a first burst bucket structure, the first limit bucket structure and the first burst bucket structure being pre-configured to control packet delivery of first incoming packets associated with a first service operated for the first client, the hierarchical bucket structure further including: a second limit bucket structure and a second burst bucket structure for the first client, the second limit bucket structure and the second burst bucket structure being pre-configured to control packet delivery of second incoming packets associated with a second service operated for the first client.

In some aspects, the techniques described herein relate to a method, wherein the method further includes allowing by burst bucket structure the current incoming packet by performing one or more operations on a single current state value of the burst bucket structure, the budget of the burst bucket structure, and the packet cost of the burst bucket structure.

In some aspects, the techniques described herein relate to a method, wherein the method further includes allowing by the global bucket structure the current incoming packet by performing one or more operations on a single current state value of the global bucket structure, the budget of the global bucket structure, and the packet cost of the global bucket structure, the packet cost of the global bucket structure being equal to the budget of the global bucket structure.

In some aspects, the techniques described herein relate to a method, wherein the method further includes selectively dropping by the burst bucket structure, in real-time, the current incoming packet.

In some aspects, the techniques described herein relate to a method, wherein method further includes selectively dropping by the global bucket structure, in real-time, the current incoming packet.

In some aspects, the techniques described herein relate to a method, wherein the system is a queue-less system.

In some aspects, the techniques described herein relate to a method, wherein the system is a lock-less state system.

In some aspects, the techniques described herein relate to a method, wherein the system is a thread-less system.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic representation of a computer system, in accordance with at least some non-limiting embodiments of the present technology.

FIG. 2 is a schematic representation of a networked system, in accordance with at least some non-limiting embodiments of the present technology.

FIG. 3 is an illustration of components executed by the server 210 for implementing a packet delivery system, in accordance with at least some non-limiting embodiments of the present technology.

FIG. 4 is an illustration of a bucket data structure employed by the PDC system of FIG. 3, in accordance with at least some non-limiting embodiments of the present technology.

FIG. 5 is an illustration of operation of the bucket data structure of FIG. 4 in a first scenario.

FIG. 6 is an illustration of operation of the bucket data structure of FIG. 4 in a second scenario.

FIG. 7 is an illustration of operation of the bucket data structure of FIG. 4 in a third scenario.

FIG. 8 is an illustration of a hierarchical bucket architecture employed by the PDC system of FIG. 3, in accordance with at least some non-limiting embodiments of the present technology.

FIG. 9 is a simplified schematic representation of the hierarchical bucket architecture of FIG. 8.

FIG. 10 is an illustration of quota usage of the server using the hierarchical bucket architecture, in accordance with at least some non-limiting embodiments of the present technology.

FIG. 11 is a scheme-block representation of a method executable by a computer system of FIG. 1, in accordance with at least some non-limiting embodiments of the present technology.

FIG. 12 is a scheme-block representation of another method executable by a computer system of FIG. 1, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

In the context of the present specification, a “server” refers to hardware capable of receiving requests (e.g., from client devices) over a network, and carrying out those requests, or causing those requests to be carried out (e.g., via one or more computer programs executed by the server). The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

With these fundamentals in place, we will now consider some non-limiting examples to illustrate various implementations of aspects of the present technology.

### Computer System

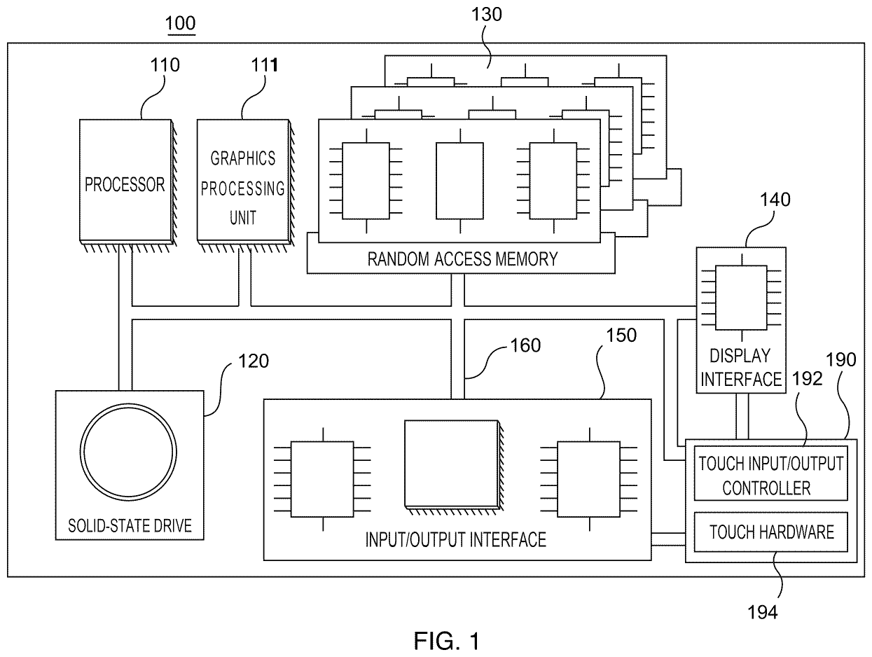

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

According to implementations of the present technology, the solid-state drive 120 stores program instructions suitable for being loaded into the random-access memory 130 and executed by the processor 110 and/or the GPU 111. For example, the program instructions may be part of a library and/or an application.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. It is noted that some components of the computer system 100 can be omitted in some non-limiting embodiments of the present technology. For example, the keyboard and the mouse (both not separately depicted) can be omitted, especially (but not limited to) where the computer system 100 is implemented as a compact electronic device.

Broadly speaking, the touchscreen 190 may comprise touch hardware 194 and a touch input/output controller 192 allowing communication with the display interface 140 and/or the one or more internal and/or external buses 160. In some embodiments, the touch hardware 194 may comprise pressure-sensitive cells embedded in a layer of a display allowing detection of a physical interaction between a user and the display.

It should be noted that various implementations of the computer system 100 are contemplated. As it will become apparent from the description herein further below, one or more computer system connected over communication network may be implemented similarly to the computer system 100, without departing from the scope of the present technology.

### Networked Environment

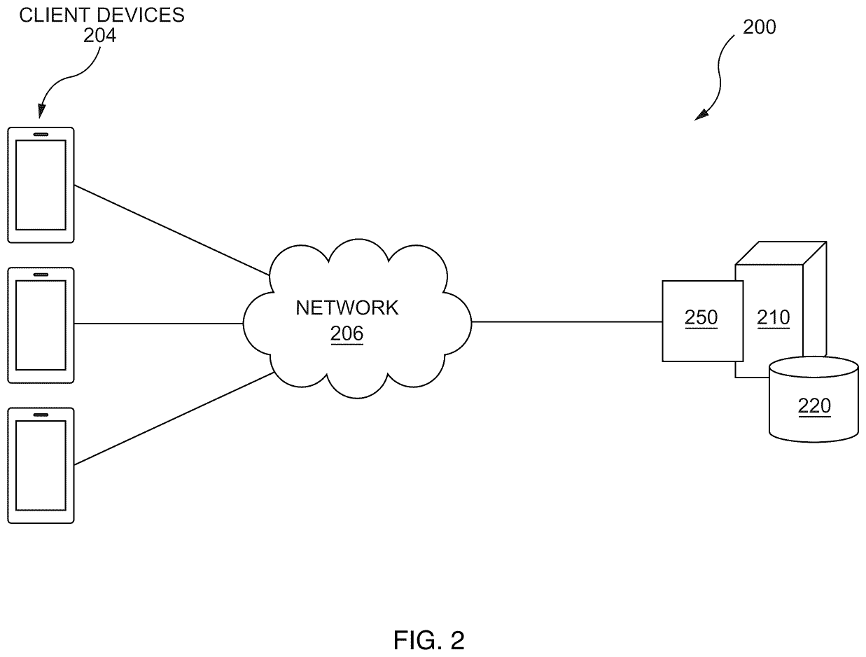

Referring to FIG. 2, there is shown a schematic diagram of a networked environment 200, the networked environment 200 being suitable for implementing non-limiting embodiments of the present technology. It is to be expressly understood that the networked environment 200 as depicted is merely an illustrative implementation of the present technology. Thus, the description thereof that follows is intended to be only a description of illustrative examples of the present technology.

Broadly speaking, the networked environment 200 is configured for providing communication between inter alia a plurality of electronic devices 204, a communication network 206, and a server 210.

As mentioned above, the networked environment 200 comprises a plurality of electronic devices comprising the electronic device 204. As such, the electronic device 204, or simply “device” 204 can sometimes be referred to as a “client device”. In the context of the present specification, unless provided expressly otherwise, “electronic device” or “device” is any computer hardware that is capable of running a software appropriate to the relevant task at hand. Thus, some non-limiting examples of the device 204 include personal computers (desktops, laptops, netbooks, etc.), smartphones, tablets and the like. The device 204 comprises hardware and/or software and/or firmware (or a combination thereof), as is known in the art, to transmit requests to the server 210.

Returning to the description of FIG. 2, the networked environment 200 comprises the communication network 206. In one non-limiting example, the communication network 206 may be implemented as the Internet. In other non-limiting examples, the communication network 206 may be implemented differently, such as any wide-area communication network, local-area communication network, a private communication network and the like. In fact, how the communication network 206 is implemented is not limiting and will depend on inter alia how other components of the networked environment 200 are implemented.

The purpose of the communication network 206 is to communicatively couple at least some of the components of the networked environment 200 such as the client devices 204, the server 210, and the database system 250. For example, this means that the server 210 is accessible via the communication network 206 by the client devices 204. The communication network 206 may be used in order to transmit requests in a form of data packets, or “packets”, between the device 204, the server 210.

The networked environment 200 comprises the server 210 that may be implemented as a conventional computer server. In an example of an embodiment of the present technology, the server 210 may be implemented as a Dell™ PowerEdge™ Server running the Linux™ operating system. Needless to say, the server 210 may be implemented in any other suitable hardware and/or software and/or firmware or a combination thereof. In the depicted non-limiting embodiment of present technology, the server 210 is a single server. In alternative non-limiting embodiments of the present technology, the functionality of the server 210 may be distributed and may be implemented via multiple servers.

In some embodiments, the server 210 may be a Domain Name System (DNS) server configured for translating human-readable domain names, such as “www.example.com”, into machine-readable IP addresses, such as “192.168.1.1” for example. This translation process, known as domain name resolution, enables clients to access websites, send emails, and utilize online services without needing to remember complex numerical IP addresses. In addition to resolving domain names, DNS servers may perform other functions. DNS servers may cache previously resolved requests to accelerate subsequent lookups and reduce the overall load on the network. DNS servers may support load balancing by distributing traffic across multiple servers to aid in provided uninterrupted service under heavy load conditions. DNS servers can relay requests to other DNS servers and/or other systems, a process called “forwarding”.

It should be noted that the server 210 comprises a Packet Deliver Control (PDC) system 250. Broadly, the PDC system 250 is configured to acquire packets transmitted to the server 210 from the one or more client devices 204 and perform a decision-making process for determining if packets are to be forwarded or dropped. The PDC system 250 will now be descried in greater details.

### Packet Delivery Control (PDC) System

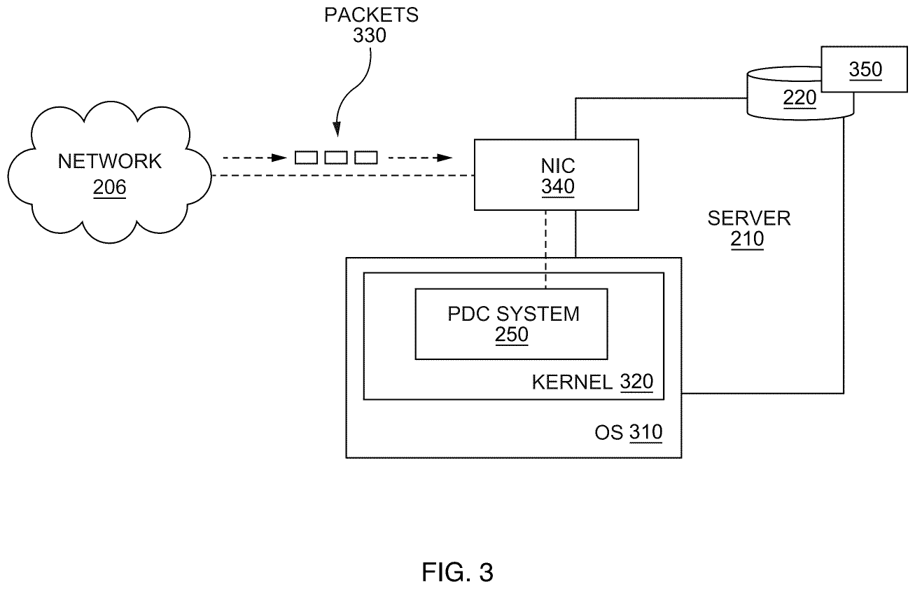

With reference to FIG. 3, there is depicted a schematic representation of components executed by the server 210 for implementing the PDC system 250. The server 210 is operated using an operating system (OS) 310. Broadly, an OS is a software control layer configured to interface with hardware components and manage software applications. The OS includes modules for resource management, including CPU scheduling, memory allocation, storage organization, and input/output handling. It provides application programming interfaces (APIs) and system calls to abstract hardware operations.

The OS 310 may comprise a process management module for scheduling and prioritizing processes, a memory management module for dynamic memory allocation and protection, and a file system module for data organization and access control. The OS 310 may comprise a device driver interface ensures compatibility with hardware peripherals, and a security module enforces authentication, access permissions, and data encryption. Additionally, the OS 310 may comprise a network communication module to support data exchange over local and wide-area networks.

The OS 310 comprises a kernel 320 that acts as a bridge between software and hardware in the server 210. For example, the kernel 320 may be responsible for managing hardware resources (e.g., processing units, memory devices) and providing essential services to applications. Linux™ is a known kernel used in some conventional operating systems.

As seen, the PDC system 250 operates at the “kernel-level” of the OS 310 and is configured to perform a decision-making process on a plurality of packets 330 acquired by a Network Interface Controller (NIC) 340 of the server 210. Broadly, a NIC is a hardware component configured to enable the server 210 to connect to and communicate over the communication network 206. The NIC 340 is operable to facilitate data transmission and reception by interfacing with the device's system bus and network media, thereby enabling network communication through wired or wireless protocols. It can be said that the PDC system 250 is configured to perform decision making on “raw” packets acquired from the physical layer of the network stack.

The PDC system 250 is configured to employ one or more “bucket” data structures to selectively forward or drop incoming packets based on a decision logic. In at least one embodiment, the PDC system 250 may be implemented as an XDP configuration in the kernel 320 with a decision logic for selective forwarding or dropping of incoming packets provided via eBPF.

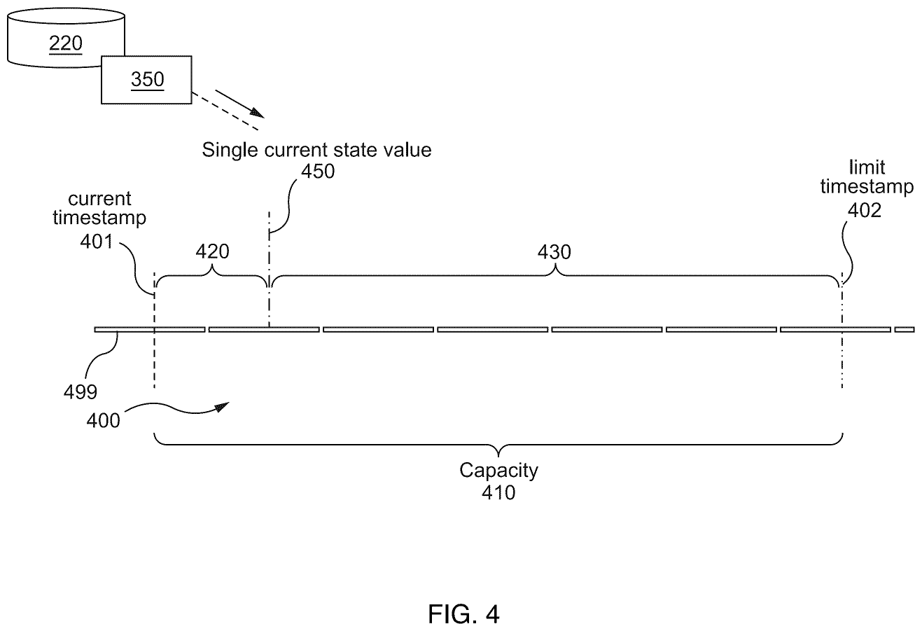

In order to maintain a given bucket data structure, the PDC system 250 may be configured to store and/or update a single state value for the given bucket in the database 220. In this embodiment, a plurality of single current state values 350 are stored in the database system 220 and are atomically updated using the decision logic. How the PDC system 250 is configured to employ and maintain the given bucket data structure with a single state value will now be described with reference to FIGS. 4 to 7. It is contemplated that one or more from the plurality of single current state values 350 may be stored in a local memory of an electronic device (e.g., the server 210) that executes the PDC system 250, without departing form the scope of the present technology.

### Single State Value (SSV) Bucket Structure

With reference to FIG. 4, there is depicted a schematic representation of a bucket data structure 400 employed by the PDC system 250 in at least some embodiments of the present technology. The bucket data structure 400 acts as a virtual container for incoming packets and is employed for selective forwarding or dropping of the incoming packets based on a decision logic.

In some embodiments, the bucket data structure 400 may be a client-specific bucket data structure, meaning that the bucket data structure 400 is configured to acquire incoming packets originating from a dedicated client only.

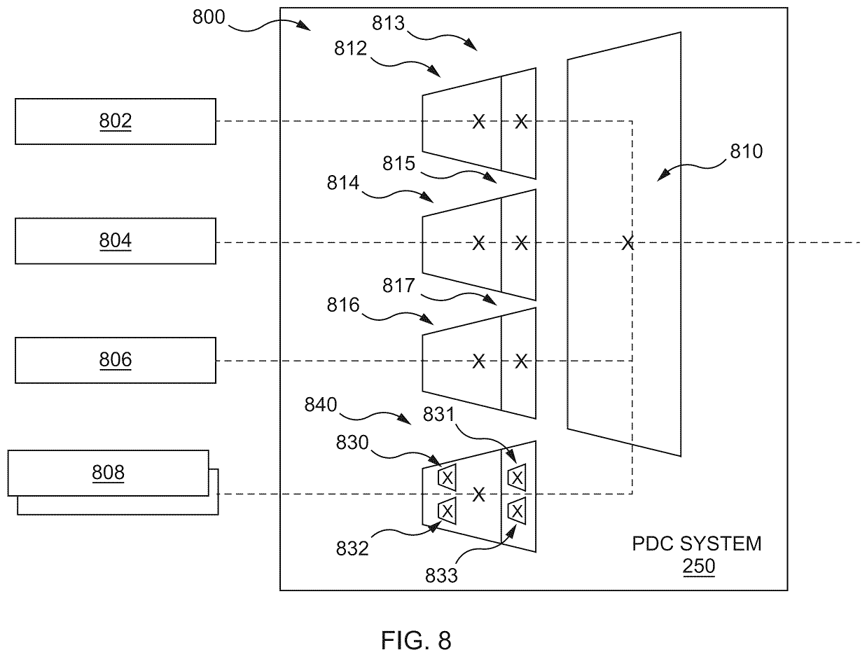

In other embodiments, the bucket data structure 400 may be a non-client-specific bucket data structure for processing incoming packets from different clients, without departing from the scope of the present technology. For example, the bucket data structure 400 may be implemented as a global bucket structure 810 (see FIG. 8).

In further embodiments, the PDC system 250 may be configured to employ a plurality of bucket data structures comprising at least one non-client-specific bucket data structure and at least one client-specific bucket data structure. For example, the PDC system may be configured to employ a plurality of bucket data structure in a hierarchical configuration (see FIG. 8).

During operation of the PDC system 250, a current “state” of the bucket data structure 400 is used for executing the decision logic on a current packet at a current moment in time. The current state of the bucket structure 400 is atomically updated in real-time depending on inter alia the specific decision logic applied on an incoming data packet.

As it will be described in greater details herein further below, in contrast to at least some conventional bucket data structures, the state of the bucket data structure 400 may be maintained in memory using a single state value. More specifically, the current state of the bucket data structure 400 can be updated in real-time by applying an atomic operation on a single current state value and thereby generating a single updated state value.

As it will become apparent from the description herein further below, unlike at least some conventional bucket data structures the bucket data structure 400 is a queue-less, lock-less, thread-less, single state value bucket data structure configured to perform selective forwarding or dropping of incoming packets in real-time.

Returning to the description of FIG. 4, the PDC system 250 is configured to perform real-time decision-making on incoming packets acquired at different moments in time along a timeline 499. It is contemplated that the PDC system 250 may have access to a system clock configured to provide a current timestamp 401 along the timeline 499 corresponding to a receipt of the incoming packet. It is contemplated that the system clock may provide a current timestamp every 1 nanosecond for allowing real-time decision iterations on incoming packets.

The bucket data structure 400 has a capacity 410 indicative of a pre-determined number of packets that can be forwarded by the bucket structure 400 at a given moment in time. It should be noted that the capacity 410 of the data bucket structure 400 is a value that can be pre-determined based on inter alia specific implementations of the present technology.

It should be noted that the pre-determined capacity value can be configured in the decision logic itself, and therefore the PDC system 250 may not require fetching a pre-determined value from memory during respective decision iterations. It is contemplated that the capacity 410 of the bucket data structure 400 may be dynamically updated by modifying a corresponding capacity value configured in the logic.

During a given decision iteration, the PDC system 250 may add the pre-determined capacity value (available from the logic) to the current timestamp 401 (available from the system clock) to determine a limit timestamp 402.

The bucket data structure 400 attributes a packet cost to respective incoming packets. Broadly, a packet cost is indicative of a pre-determined portion of the capacity 410 that a given packet uses if forwarded (e.g., allowed) by the bucket structure 400. It should be noted that the packet cost of the data bucket structure 400 is a value that can be pre-determined based on inter alia specific implementations of the present technology.

It should be noted that the pre-determined packet cost value can be configured in the decision logic itself, and therefore the PDC system 250 may not require fetching a pre-determined value from memory during respective decision iterations. It is contemplated that the packet cost of the bucket data structure 400 may be dynamically updated by modifying a corresponding packet cost value configured in the logic.

In one scenario, let it be assumed incoming packets of the bucket data structure 400 are to be processed at a rate of 3 packets per second. The rate can be determined by an operator of the PDC system 250 for a specific server and/or a specific client. In this scenario, the bucket data structure 400 can have a capacity of 3 seconds and a packet cost of 1 second. In another scenario, let it be assumed incoming packets of the bucket data structure 400 are to be processed at a rate of 30 packets per second. In this other scenario, the bucket data structure 400 can have a capacity of 3 seconds and a packet cost of 0.1 second. In a further scenario, let it be assumed incoming packets of the bucket data structure 400 are to be processed at a rate of 300 packets per second. In this other scenario, the bucket data structure 400 can have a capacity of 3 seconds and a packet cost of 0.01 second.

It should be noted that incoming packets are not per se stored, queued, or updated in the bucket data structure 400. Instead, the PDC system 250 is configured to use the current timestamp 401, the capacity 410 from the logic, the packet cost from the logic, and a single state value retrieved from memory for selectively forwarding or dropping, in real-time, an incoming packet. Unlike some traditional approaches that require two separate values to be retrieved from memory (e.g., token count and timestamp) during decision-making, the state of the bucket 400 can be retrieved and updated using one, single, state value 450 stored in the database 220.

The PDC system 250 is configured to atomically update the single current state value 450 or to keep it unchanged depending on inter alia different scenarios. It should be noted that the single current state value 450 is indicative of a portion of the capacity 410 currently used. For example, as seen FIG. 4, a portion 420 of the capacity 410 is currently used. The portion 420 is delimited by the current timestamp 401 and the single current state value 450. Also, it should be noted that a current budget 430 is available in the bucket structure 400. The current budget 430 is a portion of the capacity 410 that is not currently used. The current budget 430 is delimited by the single current state value 450 and the limit timestamp 402 (e.g., capacity limit of the bucket structure 400).

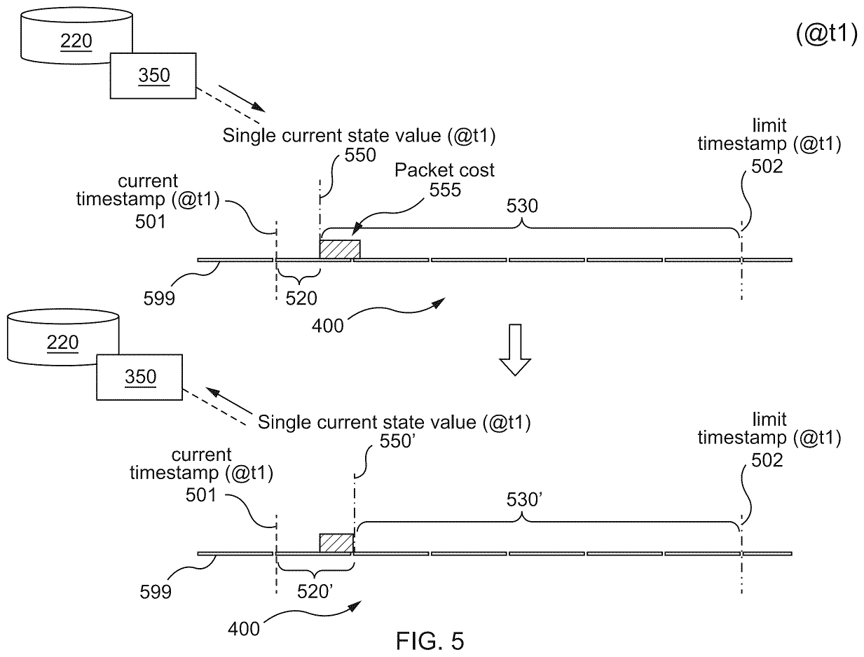

In a first scenario illustrated in FIG. 5, the PDC system 250 is configured to, at a first moment in time indicated by the system clock, retrieve the single current state value 550 and apply a decision logic on a current packet to (i) forward a current packet and (ii) atomically update the current state value 550 in memory.

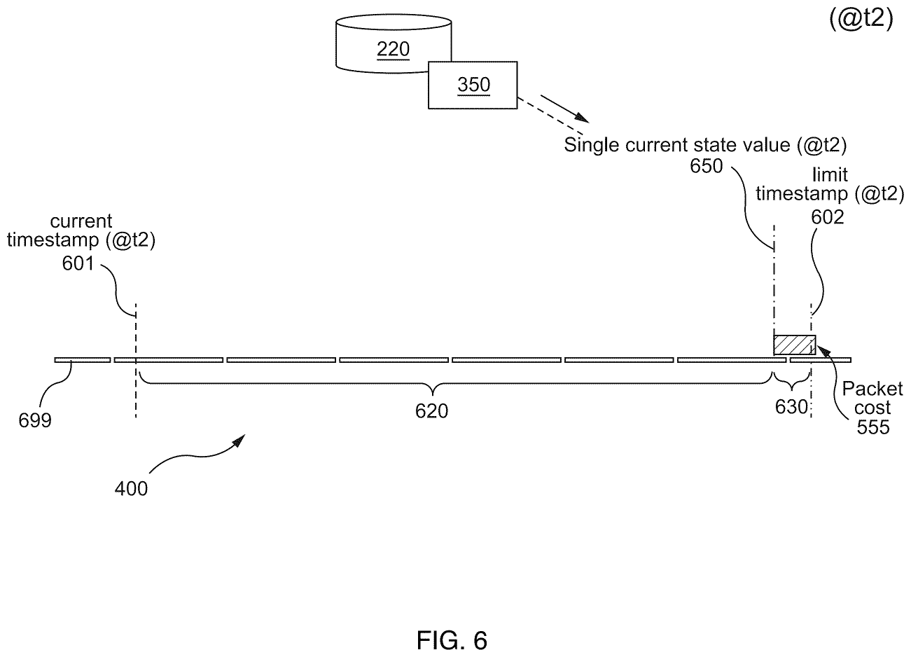

In a second scenario illustrated in FIG. 6, the PDC system 250 is configured to, at a second moment in time indicated by the system clock, retrieve the single current state value 650 and apply the decision logic on a current packet to drop the current packet while keeping the current state value 650 unchanged.

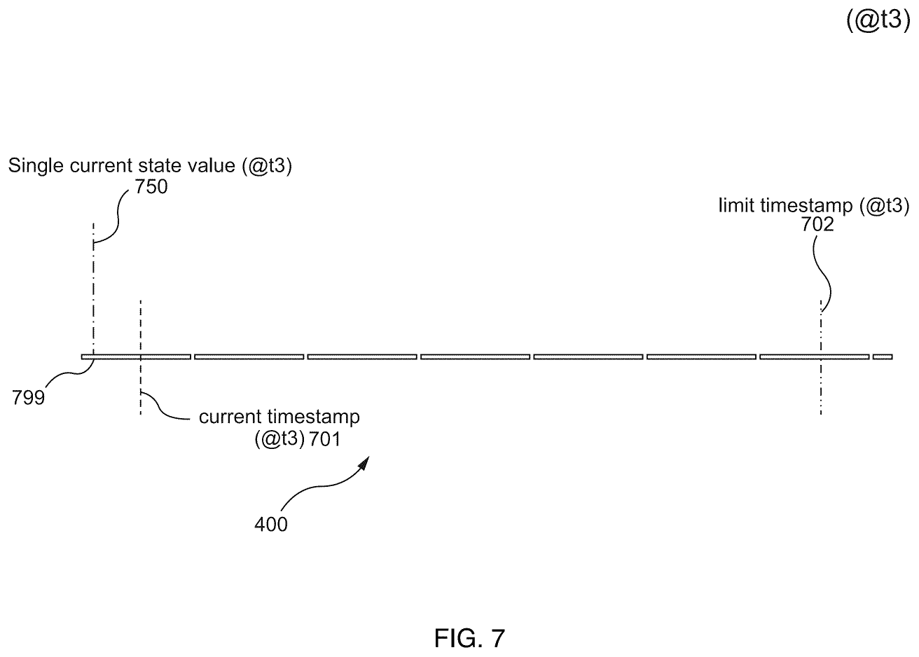

In a third scenario illustrated in FIG. 7 the PDC system 250 is configured to, at a third moment in time indicated by the system clock, retrieve the single current state value 750 and apply the decision logic to atomically update the current state value 750 in memory.

### First Scenario: Forward and Atomic Update

With reference to FIG. 5, in the first scenario, let it be assumed that at a moment of time t1 indicated by the system clock, a current incoming packet is intercepted by the PDC system 250 and is configured to perform one or more operations for selectively forwarding or dropping the current incoming packet. One or more operations performed by the PDC system 250 in the first scenario can be implemented via eBPF technology.

The PDC system 250 is configured to perform a first sum operation between the current timestamp 501 (for the moment of time t1) and the capacity 410 indicated in the decision logic. The first sum operation results in the limit timestamp 502. It can be said that this sum may be indicative of a capacity limit at the given moment in time.

The PDC system 250 is configured to perform a retrieval operation for retrieving a single current state value 550.

It should be noted that the single current state value 550 is indicative of a portion of the capacity 410 currently used. For example, as seen FIG. 5, a portion 520 of the capacity 410 is currently used. The portion 520 is delimited by the current timestamp 501 and the single current state value 550. Also, it should be noted that a current budget 530 is available in the bucket structure 400. The current budget 530 is a portion of the capacity 410 that is not currently used. The current budget 530 is delimited by the single current state value 550 and the limit timestamp 502 (e.g., capacity limit of the bucket structure 400).

The PDC system 250 is configured to perform a second sum operation between the single current state value 550 and a packet cost 555 indicated in the decision logic. The second sum operation results in a “projected” state value of the bucket data structure 400. It can be said that this sum may be indicative of a projected portion of the capacity 410 used at the given moment in time.

The PDC system 250 is configured compare the limit timestamp 502 against the projected state value. In this first scenario, the projected state value is below the limit timestamp 502. It can be said that in this first scenario, the projected portion of the capacity 410 used at the given moment in time is below the capacity limit.

As a result, the PDC system 250 is configured to selectively forward the current incoming packet for processing by the server 210 and/or other layers in network stack. Also, the PDC system 250 is configured to atomically update the single current state value 550 so that the single updated state value 550′ corresponds to the projected state value previously computed. The PDC system 250 may be configured to perform an atomic update operation on the single current state value 550 for employing the single updated state value 550′ during a sequential moment in time indicated by the system clock.

It should be noted that the single updated state value 550′ is indicative of a portion of the capacity 410 currently used following the forwarding of the current incoming packet. For example, as seen FIG. 5, a portion 520′ of the capacity 410 is currently used following the forwarding of the current incoming packet. The updated portion 520′ is delimited by the current timestamp 501 and the single updated state value 550′. Also, it should be noted that an updated budget 530′ is available in the bucket structure 400. The updated budget 530′ is a portion of the capacity 410 that is not currently used following the forwarding of the current incoming packet. The updated budget 530′ is delimited by the single updated state value 550′ and the limit timestamp 502 (e.g., capacity limit of the bucket structure 400). In other words, following the forwarding of the current incoming packet, the packet cost 555 is in a sense removed from the budget 530 and added to the portion 520, such that the updated portion 520′ is larger than the portion 520 by an amount equal to the packet cost 555, and the updated budget 530′ is smaller than the budget 530 by the amount equal to the packet cost 555.

### Second Scenario: Drop

With reference to FIG. 6, in the second scenario, let it be assumed that at a moment of time t2 indicated by the system clock, a current incoming packet is received and the PDC system 250 is configured to perform one or more operations for selectively forwarding or dropping the current incoming packet. One or more operations performed by the PDC system 250 in the second scenario can be implemented via eBPF technology.

The PDC system 250 is configured to perform a first sum operation between the current timestamp 601 (for the moment of time t2) and the capacity 410 indicated in the decision logic. The first sum operation results in the limit timestamp 602. It can be said that this sum may be indicative of a capacity limit at the given moment in time The PDC system 250 is configured to perform a retrieval operation for retrieving a single current state value 650.

It should be noted that the single current state value 650 is indicative of a portion of the capacity 410 currently used. For example, as seen FIG. 6, a portion 620 of the capacity 410 is currently used. The portion 620 is delimited by the current timestamp 601 and the single current state value 650. Also, it should be noted that a current budget 630 is available in the bucket structure 400. The current budget 630 is a portion of the capacity 410 that is not currently used. The current budget 630 is delimited by the single current state value 650 and the limit timestamp 602 (e.g., capacity limit of the bucket structure 400).

The PDC system 250 is configured to perform a second sum operation between the single current state value 650 and the packet cost 555 indicated in the decision logic. The second sum operation results in a “projected” state value of the bucket data structure 400. It can be said that this sum may be indicative of a projected portion of the capacity 410 used at the given moment in time.

The PDC system 250 is configured compare the limit timestamp 602 against the projected state value.

In this second scenario, the projected state value is above the limit timestamp 602. It can be said that, in this second scenario, the projected portion of the capacity 410 is above the capacity limit. As a result, the PDC system 250 is configured to selectively drop the current incoming packet. Also, the PDC system 250 is configured to keep the single current state value 650 unchanged. The PDC system 250 may be configured to keep the single current state value 650 unchanged in memory for employing the single current state value 650 during a sequential moment in time.

In this second scenario, it should be noted that the packet cost 555 is larger than the current budget 630 available in the bucket structure 400. As a result, the PDC system 250 may be configured to selectively drop (based on one or more operations) in real-time the current incoming packet, since forwarding the incoming packet would otherwise result in exceeding the current budget 630 available in the bucket structure 400.

### Third Scenario: Idle State A

With reference to FIG. 7, in the third scenario, let it be assumed that, at a moment of time t3 indicated by the system clock, there are no incoming packets for the bucket data structure 400. In this third scenario, when there are no new incoming packets, the PDC system 250 may be configured to operate in an “idle” state-that is, the PDC system 250 may be configured to wait until a new incoming packet arrives for performing one or more of: retrieving a single current state value and one or more operations on the single current state value. It should be noted that in the third scenario, if the bucket structure 400 did not have any new incoming packets, a single current state value 750 may be lower than a current timestamp along the timeline 799.

It should be noted that when the PDC system 250 and/or the bucket structure 400 is in the idle state, a given client associated with the given bucket structure 400 may have a comparatively low Request Per Second (RPS) consumption. Once a new incoming packet is received, the PDC system 250 may operate in an “active” state and is configured to perform one or more operations similarly to how the PDC system 250 performed operations in the first and/or second scenarios described above. For example, once a new incoming packet is available for the bucket structure 400, the single current state value 750 may be atomically updated to be equal to a current timestamp.

### Fourth Scenario: Idle State B

In this fourth scenario, let it be assumed that the single current state value 750 is below the limit timestamp 702 and is above the current timestamp 701. As a result, the PDC system 250 is configured to keep the single current state value 750 unchanged (i.e., operate in an idle state) if there is no available incoming packet. The PDC system 250 may be configured to keep the single current state value 750 unchanged and employ the single current state value 750 during a sequential moment in time when a new incoming packet is available for decision-making.

### Hierarchical Token Bucket (HTB) Architecture

With reference to FIG. 8, there is depicted a schematic representation of a hierarchical bucket architecture 800 employed by the PDC system 250 in at least some embodiments of the present technology. As it will be described below in greater details, the hierarchical bucket architecture 800 can be used to optimize bandwidth utilization between different clients of the server 210 by redistributing underutilized quotas from some clients to others, while preventing breaches of a total quota.

In this embodiment, the PDC system 250 is configured to control packet delivery from a plurality of clients comprising a first client 802, a second client 804, a third client 806, and other clients 808. In this embodiment, the hierarchical bucket architecture 800 comprises bucket structures for respective clients from the plurality of clients.

Broadly speaking, a given limit bucket is configured to manage a rate of requests per second (RPS) of a given client. A given burst bucket is configured to manage temporary bursts of traffic by accumulating unused capacity over time, enabling a given client to temporarily exceed their target rate without violating a global quota of the server 210.

For example, the hierarchical bucket architecture 800 comprises a first limit bucket structure 812 and a first burst bucket structure 813 for the first client 802. In the same example, the hierarchical bucket architecture 800 comprises a second limit bucket structure 814 and a second burst bucket structure 815 for the second client 804. It is contemplated that the first burst bucket structure 813 may be implemented similarly to how the bucket structure 400 is implemented, without departing from the scope of the present technology. It is contemplated that the second burst bucket structure 815 may be implemented similarly to how the bucket structure 400 is implemented, without departing from the scope of the present technology.

In the same example, the hierarchical bucket architecture 800 comprises a third limit bucket structure 816 and a third burst bucket structure 817 for the third client 806. It is contemplated that the third burst bucket structure 817 may be implemented similarly to how the bucket structure 400 is implemented, without departing from the scope of the present technology.

It is contemplated that the hierarchical bucket architecture 800 may comprise one or more limit bucket structures and one or more burst bucket structures for the other clients 808. For example, the hierarchical bucket architecture 800 comprises more than two bucket structures for the other clients 808. It is contemplated that one or more burst bucket structures (such as a burst bucket structure 831 and a burst bucket structure 833, for example) may be implemented similarly to how the bucket structure 400 is implemented, without departing from the scope of the present technology.

The hierarchical bucket architecture 800 comprises a main bucket structure 810. The global bucket structure 810 may be implemented similarly to how the bucket data structure 400 is implemented, without departing from the scope of the present technology. In this embodiment, the global bucket structure 810 is a most downstream bucket structure used to set an overall processing quota of the server 210 for aiding in controlling an overall usage of the server 210. In other words, the global bucket structure 810 is employed for performing decision making on incoming packets from the plurality of clients.

The hierarchical bucket architecture 800 may also allow for controlling packet delivery according to client-specific quotas. In some embodiments, the quota for the other clients 808 can be distributed between more than one different clients included in the other clients 808. The quota for a given client may be pre-determined for each client. For example, a client may be configured to purchase and/or pay for increasing its corresponding quota on the server 210. In other embodiments, it is contemplated that more than one client may be associated with the bucket structures 830 and 831, and bucket structures 832 and 832.

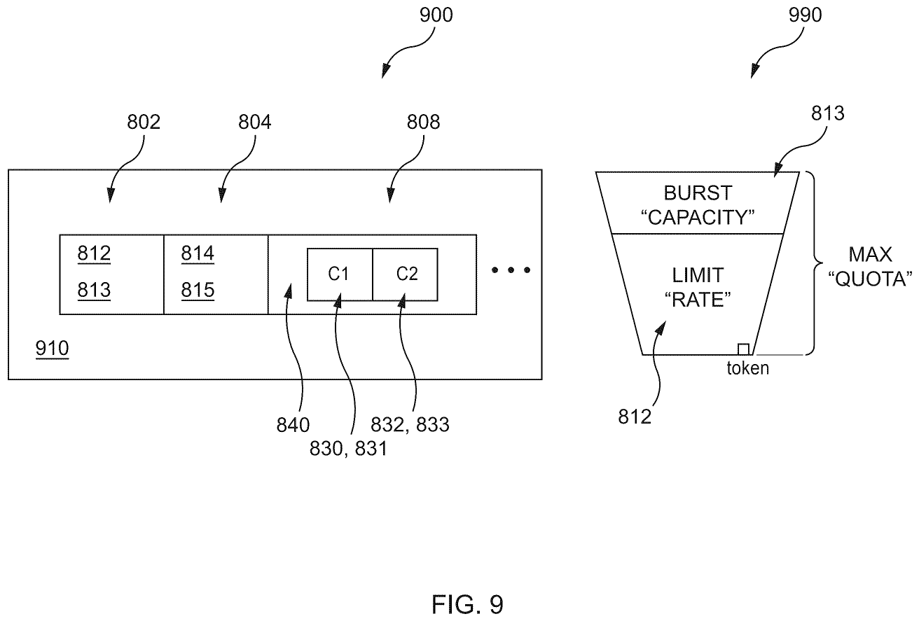

With reference to FIG. 9, there is depicted a schematic representation 900 of the hierarchical structure 800 and a schematic representation 990 of the first limit bucket 812 and of the first burst bucket 813 for the first client 802.

It is contemplated that the first limit bucket 812 and the first burst bucket 813 may share a same packet cost. In this embodiment, the first limit bucket 812 may be used to control a rate for the first client 802. The first limit bucket 812 may be configured to operate as a meter bucket for controlling the rate of packets from the first client 802. The first burst bucket 813 has a capacity for the first client 802. The capacity for the first client 802 represents a burst rate allowable (at least temporarily) for the first client 802. The sum of the capacity and of the rate for the first client 802 represents a maximum quota that is allowable for the first client 802. It should be noted that the larger the capacity of the first burst bucket 813 is, the more the first client 802 may (at least temporarily) exceed its rate of the first limit bucket 812.

The global bucket 810 may be used to prevent the global quota of the server 210 to exceed a maximum global quota of the server 210. The quota of the server 210 may be distributed amongst the plurality of clients.

In one example, the PDC system 250 may be configured with an other-common bucket structure 840. In this example, the quota of the other clients 808 can also be distributed among a first other client and a second other client. As a result, packets from the first other client and packets from the second other client can be controlled using respective bucket structure(s). In this example, delivery of packets from the first other client amongst the other clients 808 may be controlled using a limit bucket 830 and a burst bucket 831. In this example, delivery of packets from the second other client amongst the other clients 808 may be controlled using a limit bucket 832 and a burst bucket 833. In some embodiments, the capacity of the burst bucket 831 may be equal to a packet cost of the burst bucket 831. In some embodiments, the capacity of the burst bucket 833 may be equal to a packet cost of the burst bucket 833.

In this example, when packets from the other clients 808 are acquired, the PDC system 250 is first configured to perform decision-making using the other-common bucket 840. The PDC system 250 may then be configured to classify packets into the packets from the first other client and the second other client. If a given packet is allowed by the other-common bucket 840 and is from the first other client, the PDC system 250 is configured to perform decision-making on the given packet using the limit bucket 830 and/or the burst bucket 831. If a given packet is allowed by the other-common bucket 840 and is from the second other client, the PDC system 250 is configured to perform decision-making on the given packet using the limit bucket 832 and/or the burst bucket 833.

In this embodiment, the other-common bucket 840 may be configured as a given limit bucket. The other-common bucket 840 for the other clients may not have a corresponding burst bucket (and/or may have a burst bucket having a capacity equal to its packet cost). The other-common bucket 840 is configured for a rate that cannot be exceeded by a given client and/or all clients amongst the other clients 808. In this embodiment, the other-common bucket 840 is part of a hierarchical architecture in which each other client has its own specific bucket(s) (e.g., the limit bucket 830 and the burst bucket 831 for the first other client, and the limit bucket 832 and the burst bucket 833 for the second other client). In some embodiments, one or more of the burst buckets 831 and 833 may be omitted and/or may have corresponding capacities equal to a single corresponding packet cost.

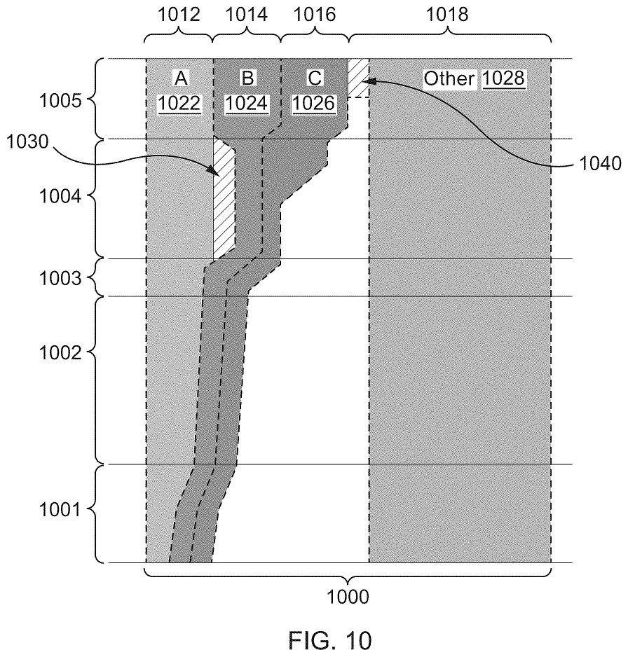

With reference to FIG. 10, there is depicted a schematic representation of a total quota 1000 of the server 210 and usage of this total quota 1000 by a plurality of clients of the server 210. It is contemplated that a hierarchical bucket architecture similar to the hierarchical structure 800 may allow for quota redistribution between the plurality of clients without exceeding the total quota 1000. As it will become apparent from the description herein further below, underutilized quotas from some clients can be temporarily “borrowed” by other clients while maintaining the total quota of the server 210 below a maximum quota of the server 210.

For example, let it be assumed that the PDC system 250 is configured to acquire incoming packets from a first client 1022, a second client 1024, and a third client 1026. Let it be assumed that the first client 1022, the second client 1024, and the third client 1026 are premium clients. Also, let it be assumed that the PDC system 250 may be configured to acquire incoming packets from a plurality of other clients 1028 that are not premium clients. It should be noted that the rates for the first client 1022, the second client 1024, and the third client 1026 may be guaranteed. The first client 1022 is associated with a first client rate 1012, the second client 1024 is associated with a second client rate 1014, the third client 1026 is associated with a third rate 1016, and the other clients are associated with a shared rate 1018.

During a time interval 1001, the first client 1022, the second client 1024, the third client 1026, and the other clients 1028 use the server 210 within their respective rates. During a time interval 1002, the first client 1022 gradually increases its traffic rate. However, the first client 1022 still uses the server 210 within its respective rate (e.g., rate of its limit bucket).

During a time interval 1003, the first client 1022 reaches the rate of its limit bucket, but the second client 1024 and the third client 1026 are still underusing the rates of their respective limit buckets. In this scenario, during the time interval 1003, incoming packets from the first client 1022, the second client 1024, the third client 1026, and the other clients 1028 are forwarded to the server 210 by checking usage against respective client's limit buckets. Since the limit buckets permit forwarding requests, they do not check the burst buckets and take tokens from the burst buckets and from the main bucket.

During a time interval 1004, the first client 1022 requires a higher rate than the rate 1012 of the corresponding limit bucket, and its limit bucket doesn't allow a further incoming packet. In this scenario, the PDC system 250 may be configured to determine whether the burst bucket for the first client 1022 allows the incoming packet. If the burst bucket of the first client 1022 has unused capacity (e.g., has available budget), the PDC system 250 may allow a rate increase for the first client 1022 if the main bucket allows it. At the time interval 1004, since the second client 1024 and the third client 1026 are not fully using the rates of their respective limit buckets, the global bucket may contain free/available tokens. Therefore, in this scenario, the PDC system 250 may allow for increasing the rate for the first client 1022 and consume free/available tokens from both the main bucket of the PDC system 250 and the burst bucket of the first client 1022. A zone 1030 is indicative of an amount of packets forwarded by the PDC system 250 even though the rate of the limit bucket for the first client 1022 has been exceeded.

During a time interval 1005, the first client 1022 has consumed all the capacity in its burst bucket and the PDC system 250 is configured to drop packets that would exceed the rate 1012 of the limit bucket of the first client 1022. In other words, the PDC system 250 controls packet delivery so as to revert to the rate 1012 for the first client 1022.

Also during the time interval 1005, the second client 1024 fully utilizes the rate 1014 of its own limit bucket. Also during the time interval 1005, the third client 1026 increases its usage beyond the rate 1016 of its own limit bucket. In this scenario, the PDC system 250 may allow the third client 1026 to increase its rate beyond the rate 1016 by consuming free/available tokens from the global bucket, because the other clients 1028 are underutilising the rate 1018 of their limit bucket(s). In other words, although these tokens were intended for the other clients 1028 but are currently available, the PDC system 250 may allow increasing the rate for the third client 1016. A zone 1040 is indicative of an amount of packets forwarded by the PDC system 250 even though the rate of the limit bucket for the third client 1026 has been exceeded.

Developers have realized that a hierarchical decision-making on incoming packet traffic may be desired to optimize usage of the server 210. Let it be assumed that a target quota of the server 210 is 50 RPS. It is contemplated that the target quota may be pre-determined based on inter alia client demands and server capabilities.

Furthermore, client-specific rates and/or quotas may be pre-determined based on client demand. For example, a target rate of 30 RPS may be set for a first client, and a target rate of 20 RPS for a second client. In this example, if the first client is underusing its rate and the second client runs out of its rate, incoming packets for the second client, that would otherwise be dropped may benefit from available bandwidth (due to underusage by the first client), are forwarded for processing by the server 210.

In at least some embodiments of the present technology, the PDC system 250 may be configured to implement a hierarchical bucket structure for controlling delivery of packets to the server 210. the PDC system 250 may receive from a first client from the plurality of clients a request comprising one packet. The PDC system 250 may classify the request and send corresponding packet to a bucket structure associated with the first client. The bucket structure associated with the first client may comprise a limit bucket and a burst bucket for the first client. In this embodiment, the PDC system 250 may be configured to perform a decision-making process using the limit bucket for the first client, the burst bucket for the first client and a main bucket. If the limit allows the package, then a token (cost of the package) is debited from the global bucket, from the burst bucket, and the limit bucket, and the package is forwarded for processing. If the limit bucket does not allow the packet to pass, then a check on the burst bucket is performed. If the burst bucket allows the packet to pass, then the check on the global bucket is performed. A token (cost of the package) may be debited from the burst bucket. If the global bucket does not allow the passage of the package, the package is dropped, and the cost of the package is returned to the burst bucket. If the global bucket allows the package to pass, then the token is debited from the global bucket and from the burst bucket and then the package is then forwarded for processing. If the burst bucket does not allow the packet to pass, then the packet is dropped.

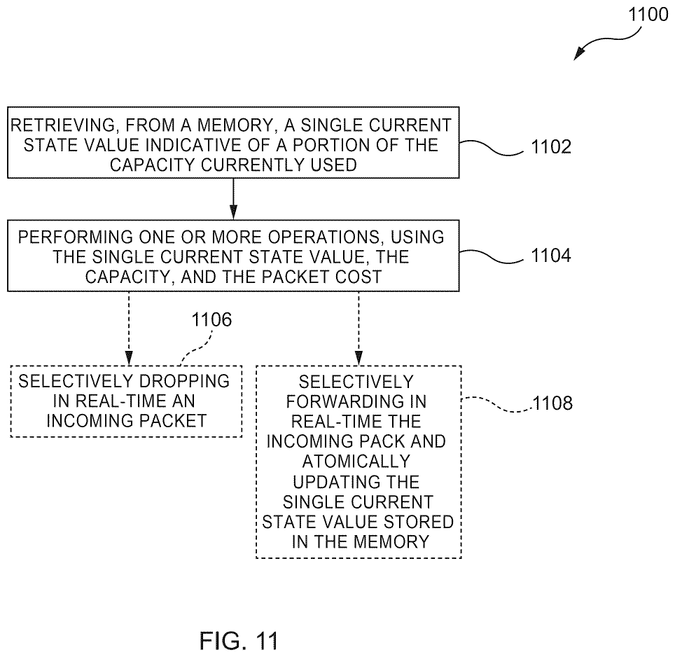

With reference to FIG. 11, there is depicted a scheme-block representation of a method 1100 executable by a server. In some embodiments, the method 1100 may be executed using the PDC system 250 of the server 210. Various steps of the method 1100 will now be discussed in greater details.

### Step 1102: Retrieving, from a Memory, a Single Current State Value Indicative of a Portion of the Capacity Currently Used

The method 1100 begins at step 1102 with the PDC system 250 configured to retrieve, from a memory, a single current state value indicative of a portion of a capacity of a given bucket structure that is currently used. For example, with reference to FIG. 5, the PDC system 250 may be configured to retrieve the single current state value 550 for the bucket structure 400. In an other example, with reference to FIG. 6, the PDC system 250 may be configured to retrieve the single current state value 650 for the bucket structure 400.

Ine some embodiments of the present technology, the PDC system 250 comprises the bucket structure 400 and/or one or more other bucket structures implemented similarly to how the bucket structure 400 is implemented. The bucket structure 400 has the capacity 410 and the packet cost 555. The capacity 410 is indicative of a pre-determined number of packets that can be forwarded by the bucket structure 400 at a given moment in time (e.g., in a burst configuration). The packet cost 555 is indicative of a pre-determined portion of the capacity 410 that a given packet uses if forwarded by the bucket structure 400.

The single current state value 550 in the scenario of FIG. 5 is indicative of the portion 520 of the capacity 410 currently used at t1. For example, the PDC system 250 may be configured to perform decision-making on a first incoming packet at t1.

The single current state value 650 in the scenario of FIG. 6 is indicative of the portion 620 of the capacity 410 currently used at t2. For example, the PDC system 250 may be configured to perform decision-making on a second incoming packet at t2.

It is contemplated that the PDC system 250 may be at least one of: a queue-less system, a lock-less state system, and a thread-less system.

### Step 1104: Performing One or More Operations, using the Single Current State Value, the Capacity, and the Packet Cost

The method 1100 continues to step 1104 with the PDC system 250 configured to perform one or more operations using the single current state value (retrieved at the step 1102), the capacity of the bucket structure, and the packet cost of the incoming packet. For example, with reference to FIG. 5, the PDC system 250 may be configured to perform one or more operations on the single current state value 550, the capacity 410, and the packet cost of 555. In an other example, with reference to FIG. 6, the PDC system 250 may be configured to perform one or more operations on the single current state value 650, the capacity 410, and the packet cost of 555.

It is contemplated that the PDC system 250 may be configured with a pre-determined capacity and a pre-determined packet cost. Developers have realized that having pre-determined values for the capacity and the packet cost for a given bucket structure may allow to store and/or atomically update and/or retrieve only one single state value (i.e., the current state value) for the given bucket structure.

In some embodiments, the PDC system 250 may be configured to performe at least one operation by determining a first sum between the single current state value and the packet cost. The first sum is indicative of a projected portion of the capacity used at the given moment in time. In the scenario of FIG. 5, the PDC system 250 may be configured to determine a first sum between the single current state value 550 and the packet cost 555. The first sum is indicative of a projected portion of the capacity 410 used at the given moment in time. In the scenario of FIG. 6, the PDC system 250 may be configured to determine a first sum between the single current state value 650 and the packet cost 555. The first sum is indicative of a projected portion of the capacity 410 used at that given moment in time.

In some embodiments, the PDC system 250 may be configured to perform at least one operation by determining a second sum between the current timestamp and the capacity. The second sum is indicative of a capacity limit at the given moment in time. In the scenario of FIG. 5, the PDC system 250 may be configured to determine a second sum between the current timestamp 501 at t1 and the capacity 410. The second sum is indicative of a capacity limit at the given moment in time (e.g., the limit timestamp at t1). In the scenario of FIG. 6, the PDC system 250 may be configured to determine a second sum between the current timestamp 601 at t1 and the capacity 410. The second sum is indicative of a capacity limit at that given moment in time (e.g., the limit timestamp at t2).

In some embodiments, the PDC system 250 may be configured to perform one or more comparison operations between the first sum and the second sum. For example, the PDC system 250 may be configured to compare the projection portion of the capacity of the bucket structure 400 at a given moment in time and a capacity limit at that given moment in time.

It is contemplated that based on the one or more operations executed by the PDC system 250 at the step 1104, the PDC system 250 may be configured to perform decision making on the incoming packet.

### STEP 1106: Selectively Dropping in Real-Time an Incoming Packet

In at least some embodiments of the method 1100, the PDC system 250 may be configured to selectively drop in real-time an incoming packet. For example, in the scenario of FIG. 6, the PDC system 250 may be configured to selectively drop the second incoming packet based on the one or more operations on the single current state value 650, the capacity 410, and the packet cost of 555. If the first sum is above the second sum, and thereby the projected portion of the capacity 410 in the scenario of FIG. 6 is above the capacity limit 602, the PDC system 250 is configured to selectively drop in real-time the second incoming packet.

### Step 1108: Selectively Forwarding in Real-Time the Incoming Packet and Atomically Updating the Single Current State Value Stored in the Memory

In at least some embodiments of the method 1100, the PDC system 250 may be configured to selectively forward in real-time the incoming packet and atomically update the single current state value in the memory. For example, in the scenario of FIG. 5, the PDC system 250 may be configured to selectively forward the first incoming packet based on the one or more operations on the single current state value 550, the capacity 410, and the packet cost of 555 and atomically update the single current state value 550 in the memory. For example, the single updated state value 550′ may be atomically stored in the memory. The memory may be a local memory of the server 210. If the first sum is below the second sum, and thereby the projected portion of the capacity 410 in the scenario of FIG. 5 is below the capacity limit 502, the PDC system 250 may be configured to selectively forward in real-time the first incoming packet for processing and atomically update the single current state value 550 stored in the memory, so that a single updated state value 550′ corresponding to the first sum is stored in the memory.

In at least some embodiments of the present technology, the selective dropping in real-time of a given incoming packet (such as in the scenario of FIG. 6) may allow preventing a DDoS attack on the DNS server since the bucket structure 400 may not allow forwarding packets once the capacity 410 is substantially used and/or when the budget of the bucket structure 400 is below a packet cost of the bucket structure 400.

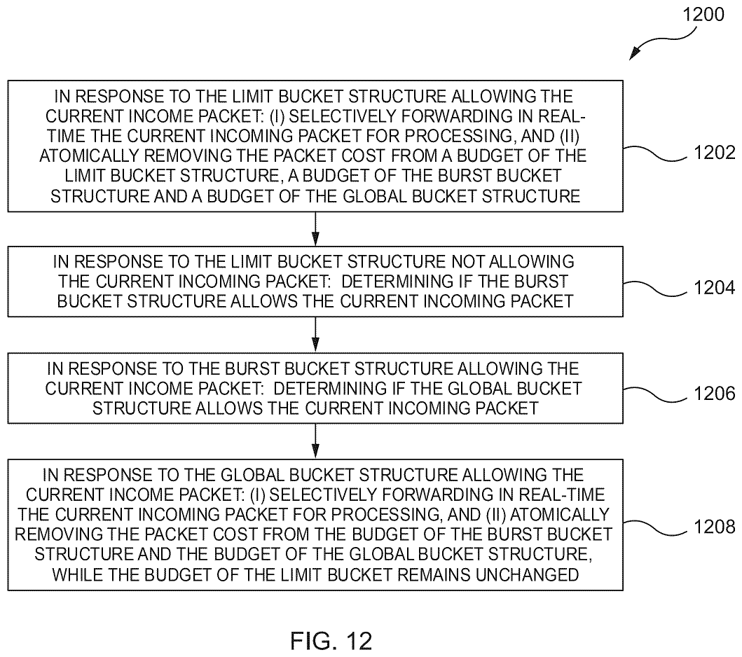

With reference to FIG. 12, there is depicted a scheme-block representation of a method 1200 executable by a server. In some embodiments, the method 1200 may be executed using the PDC system 250 of the server 210. Various steps of the method 1200 will now be discussed in greater details.

### Step 1202: In Response to the Limit Bucket Structure Allowing the Current Income Packet: (i) Selectively Forwarding in Real-Time the Current Incoming Packet for Processing, and (ii) Atomically Removing the Packet Cost from a Budget of the Limit Bucket Structure, a budget of the burst Bucket Structure and a Budget of the global bucket structure

The method 1200 begins at step 1202 with the PDC system 250 configured to, in response to a limit bucket structure allowing a current income packet, (i) selectively forward in real-time the current incoming packet for processing, and (ii) atomically removing the packet cost from a budget of the limit bucket structure, a budget of the burst bucket structure, and a budget of the global bucket structure.

For example, with reference to FIG. 8, the PDC system 250 may be configured to perform decision-making and/or classification of an incoming packet from the first client 802. In this example, the PDC system 250 may be configured to, in response to the first limit bucket structure 812 allowing the current income packet, (i) selectively forward in real-time the current incoming packet for processing, and (ii) atomically removing the packet cost from the budget of the limit bucket structure 812, the budget of the burst bucket structure 813, and the budget of the global bucket structure 810. It is contemplated that the budget of a given bucket structure is a portion of the capacity of the corresponding bucket structure that is not currently used.

It should be noted that atomically removing the packet cost from the budget of a given bucket structure may be performed similarly to how the single current state value of the bucket structure 400 is atomically updated by the PDC system 250, without departing from the scope of the present technology.

### Step 1204: In Response to the Limit Bucket Structure not Allowing the Current Incoming Packet: Determining if the Burst Bucket Structure Allows the Current Incoming Packet

The method 1200 continues to step 1204 with the PDC system 250 configured to, in response to the limit bucket structure not allowing the current incoming packet, determine if the burst bucket structure allows the current incoming packet. For example, the PDC system 250 may be configured to, in response to the first limit bucket structure 812 not allowing the current incoming packet, determine if the first burst bucket structure 813 allows the current incoming packet.

### Step 1206: In Response to the Burst Bucket Structure Allowing the Current Income Packet: Determining if the Global Bucket Structure Allows the Current Incoming Packet

The method 1200 continues to step 1206 with the PDC system 250 configured to, in response to the burst bucket structure allowing the current income packet, determine if the global bucket structure allows the current incoming packet. For example, the PDC system 250 may be configured to, in response to the first burst bucket structure 813 allowing the current income packet, determine if the global bucket structure 810 allows the current incoming packet.

It should be noted that the PDC system 250 may be configured to determine that the first burst bucket structure 813 allows the current income packet may be performed similarly to how the PDC system 250 is configured to determine that the bucket structure 400 allows the current income packet in the scenario of FIG. 5.

### Step 1208: In Response to the Global Bucket Structure Allowing the Current Income Packet: (i) Selectively Forwarding in Real-Time the Current Incoming Packet for Processing, and (ii) Atomically Removing the Packet Cost from the Budget of the Burst Bucket Structure and the Budget of the Global Bucket Structure, While the Budget of the Limit Bucket Remains Unchanged

The method 1200 continues to step 1208 with the PDC system 250 configured to, in response to the global bucket structure allowing the current income packet: (i) selectively forwarding in real-time the current incoming packet for processing, and (ii) atomically removing the packet cost from the budget of the burst bucket structure and the budget of the global bucket structure, while the budget of the limit bucket remains unchanged. For example, the PDC system 250 may be configured to, in response to the global bucket structure 810 allowing the current income packet, (i) selectively forward in real-time the current incoming packet for processing, and (ii) atomically remove the packet cost from the budget of the first burst bucket structure 813 and the budget of the global bucket structure 810, while the budget of the first limit bucket remains unchanged.

It should be noted that the PDC system 250 may be configured to atomically remove the packet cost from the budget of the first burst bucket structure 813 similarly to how the PDC system 250 is configured to atomically update the single current state value 550 in the scenario of FIG. 5, without departing from the scope of the present technology. It should be noted that the PDC system 250 may be configured to atomically remove the packet cost from the budget of the global bucket structure 810, similarly to how the PDC system 250 is configured to atomically update the single current state value 550 in the scenario of FIG. 5, without departing from the scope of the present technology.

In some embodiments, the first limit bucket structure 812 and the burst bucket structure 813 may be client-specific bucket structures pre-configured for the first client 802.

In other embodiments, the first burst bucket structure 813 may be configured to allow the current incoming packet by performing one or more operations on a single current state value of the first burst bucket structure, the budget (and/or capacity) of the first burst bucket structure 813, and the packet cost of the first burst bucket structure 813. These one or more operations may be performed similarly to the one or more operations performed by the PDC system 250 on the single current state value of the bucket structure 400, the budget (and/or capacity 410) of the bucket structure 400, and the packet cost 555 of the bucket structure 400.

In further embodiments, the global bucket structure 810 may be configured to allow the current incoming packet by performing one or more operations on a single current state value of the global bucket structure 810, the budget of the global bucket structure 810, and the packet cost of the global bucket structure 810. The packet cost of the global bucket structure 810 may be equal to the budget of the global bucket structure 810. These one or more operations may be performed similarly to the one or more operations performed by the PDC system 250 on the single current state value of the bucket structure 400, the budget (and/or capacity 410) of the bucket structure 400, and the packet cost 555 of the bucket structure 400, and where the capacity 410 of the bucket structure 400 is equal to the packet cost 555.

It is contemplated that the first burst bucket structure 813 may be configured to selectively drop, in real-time, the current income packet. It is contemplated that the global bucket structure 810 may be configured to selectively drop, in real-time, the current income packet.

It should be apparent to those skilled in the art that at least some embodiments of the present technology aim to expand a range of technical solutions for addressing a particular technical problem encountered by the conventional digital content item recommendation systems, namely selecting and providing for display digital content items that are relevant to the users.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

1. A system for controlling packet delivery to a server, the system comprising:
a hierarchical bucket structure for a plurality of clients, the hierarchical bucket structure comprising:
a global bucket structure for incoming packets from the plurality of clients, and
a limit bucket structure and a burst bucket structure for incoming packets from a first client from the plurality of clients,
the system being configured to:
in response to the limit bucket structure allowing the current income packet:
selectively forward in real-time the current incoming packet for processing, and
atomically remove the packet cost from a budget of the limit bucket structure, a budget of the burst bucket structure and a budget of the global bucket structure;
in response to the limit bucket structure not allowing the current incoming packet:
determine if the burst bucket structure allows the current incoming packet;
in response to the burst bucket structure allowing the current income packet:
determine if the global bucket structure allows the current incoming packet; and
in response to the global bucket structure allowing the current income packet:
selectively forward in real-time the current incoming packet for processing, and
atomically remove the packet cost from the budget of the burst bucket structure and the budget of the global bucket structure, while the budget of the limit bucket remains unchanged.

2. The system of claim 1, wherein the limit bucket structure and the burst bucket structure are client-specific bucket structures pre-configured for the first client.

3. The system of claim 1, wherein the limit bucket structure is a first limit bucket structure, and the burst bucket structure is a first burst bucket structure, the first limit bucket structure and the first burst bucket structure being pre-configured to control packet delivery of first incoming packets associated with a first service operated for the first client,
the hierarchical bucket structure further comprising:
a second limit bucket structure and a second burst bucket structure for the first client, the second limit bucket structure and the second burst bucket structure being pre-configured to control packet delivery of second incoming packets associated with a second service operated for the first client.

4. The system of claim 1, wherein the burst bucket structure is configured to allow the current incoming packet by performing one or more operations on a single current state value of the burst bucket structure, the budget of the burst bucket structure, and the packet cost of the burst bucket structure.

5. The system of claim 1, wherein the global bucket structure is configured to allow the current incoming packet by performing one or more operations on a single current state value of the global bucket structure, the budget of the global bucket structure, and the packet cost of the global bucket structure, the packet cost of the global bucket structure being equal to the budget of the global bucket structure.

6. The system of claim 1, wherein the burst bucket structure is configured to selectively drop, in real-time, the current income packet.

7. The system of claim 1, wherein the global bucket structure is configured to selectively drop, in real-time, the current income packet.

8. The system of claim 1, wherein the system is a queue-less system.

9. The system of claim 1, wherein the system is a lock-less state system.

10. The system of claim 1, wherein the system is a thread-less system.

11. A method of controlling packet delivery to a server, the method executable by a system,
the system comprising a hierarchical bucket structure for a plurality of clients, the hierarchical bucket structure comprising a global bucket structure for incoming packets from the plurality of clients, and a limit bucket structure and a burst bucket structure for incoming packets from a first client from the plurality of clients,
the method comprising:
in response to the limit bucket structure allowing the current income packet:
selectively forwarding in real-time the current incoming packet for processing, and
atomically removing the packet cost from a budget of the limit bucket structure, a budget of the burst bucket structure and a budget of the global bucket structure;
in response to the limit bucket structure not allowing the current incoming packet:
determining if the burst bucket structure allows the current incoming packet;
in response to the burst bucket structure allowing the current income packet:
determining if the global bucket structure allows the current incoming packet; and
in response to the global bucket structure allowing the current income packet:
selectively forwarding in real-time the current incoming packet for processing, and
atomically removing the packet cost from the budget of the burst bucket structure and the budget of the global bucket structure, while the budget of the limit bucket remains unchanged.

12. The method of claim 11, wherein the limit bucket structure and the burst bucket structure are client-specific bucket structures pre-configured for the first client.

13. The method of claim 11, wherein the limit bucket structure is a first limit bucket structure, and the burst bucket structure is a first burst bucket structure, the first limit bucket structure and the first burst bucket structure being pre-configured to control packet delivery of first incoming packets associated with a first service operated for the first client,
the hierarchical bucket structure further comprising:
a second limit bucket structure and a second burst bucket structure for the first client, the second limit bucket structure and the second burst bucket structure being pre-configured to control packet delivery of second incoming packets associated with a second service operated for the first client.

14. The method of claim 11, wherein the method further comprises allowing by burst bucket structure the current incoming packet by performing one or more operations on a single current state value of the burst bucket structure, the budget of the burst bucket structure, and the packet cost of the burst bucket structure.

15. The method of claim 11, wherein the method further comprises allowing by the global bucket structure the current incoming packet by performing one or more operations on a single current state value of the global bucket structure, the budget of the global bucket structure, and the packet cost of the global bucket structure, the packet cost of the global bucket structure being equal to the budget of the global bucket structure.

16. The method of claim 11, wherein the method further comprises selectively dropping by the burst bucket structure, in real-time, the current incoming packet.

17. The method of claim 11, wherein method further comprises selectively dropping by the global bucket structure, in real-time, the current incoming packet.

18. The method of claim 11, wherein the system is a queue-less system.

19. The method of claim 11, wherein the system is a lock-less state system.

20. The method of claim 11, wherein the system is a thread-less system.
